(19) United States
(12) Patent Application Publication
(10) Pub. No.: US 2005/0012931 A1
(43) Pub. Date: Jan. 20, 2005

(54) Method and apparatus for rapidly and accurately determining a time constant from cavity ring-down data

(76) Inventors: Sze Tan, Sunnyvale, CA (US); Bernard Fidric, Cupertino, CA (US); Robert Lodenkamper, Sunnyvale, CA (US)

Correspondence Address: John F. Schipper, Esq., Suite 808, 111 N. Market Street, San Jose, CA, 95113, US

(21) Appl. No.: 10/622,323

(22) Filed: Jul. 17, 2003

(51) Int. Cl. G01N 21/00

(52) U.S. Cl. 356/437

(57) ABSTRACT

Methods and apparatus for decreasing the time required to calculate a ring-down time from sampled ring-down data and/or increasing the accuracy of the calculated ring-down time are provided. The time required to obtain an accurate calculation of a ring-down time is reduced by performing a linear least squares fit using an estimate B1 of the background, then using the results of the fit to estimate the error in B1. The estimated error in B1 is then used to provide an improved estimate of the ring-down time. Alternatively, the time required to accurately calculate a ring-down time is reduced by averaging consecutive data points into “bins” and performing a linear least squares fit to the resulting binned signal. The parameters obtained from the fit to the binned signal are then used to obtain an improved estimate B2 of the background, and the ring-down time is calculated by performing a linear least squares fit using B2. Another method, applicable either by itself or in combination with either of the two preceding methods, is to improve accuracy by providing a low pass filter having a bandwidth related to a shortest expected ring-down time, to filter the ring-down signal before it is sampled.

### FIELD OF THE INVENTION

This invention relates to optical measurements performed using a ring-down cavity, and more specifically to methods for determining a decay time of a ring-down cavity from measured data.

### BACKGROUND

Cavity ring-down spectroscopy (CRDS) is a method for measuring certain optical properties (e.g., extinction or scattering coefficients) of a sample positioned within an optical resonator. In CRDS, optical radiation from a source (typically a laser source) is coupled into the resonator (also referred to as a ring-down cavity) such that source radiation circulates within the resonator. When the coupling between the source and the ring-down cavity is interrupted (e.g., by turning off or blocking the source, or by reducing the overlap of the source spectrum with the cavity mode spectrum), the intensity of the source radiation trapped within the resonator decays in time. The time decay of the trapped radiation is typically exponential, with a time constant referred to as the ring-down time. The ring-down time depends on the total round trip loss within the resonator, including mirror losses and losses due to absorption and/or scattering by an analyte within a sample placed within the resonator. The presence and/or concentration of the analyte can be determined by measurements of the ring-down time, since the ring-down time depends on analyte-induced loss. Typically, the ring-down time is calculated from an intensity vs. time signal obtained by detecting radiation transmitted through one of the resonator mirrors, although it is also possible to use an intensity vs. time signal obtained by detecting radiation scattered from within the cavity.

The calculation of the ring-down time from an analog ring-down signal (i.e., intensity vs. time data) can be performed by analog methods or by digital methods. U.S. Pat. No. 6,233,052, incorporated by reference herein, advances analog methods for ring-down time calculation over prior digital methods which were noted as having limitations and drawbacks. While analog calculation of the ring-down time tends to be faster than digital calculation of the ring-down time, analog detection for CRDS places severe requirements on the performance of the associated electronics, particularly the logarithmic amplifier. Digital methods for calculating the ring-down time include the step of sampling the analog ring-down signal (typically with a suitably chosen sampling time Ts separating adjacent sample points) to obtain a table of data points each having a time and a value (i.e., intensity). Various curve fitting methods can be applied to this table of data points in order to extract the ring-down time. Such a curve fitting method can be implemented in hardware and/or in software.

The model that is fit to the data points in a digital calculation of the ring-down time is typically of the form
f(t)=A exp(−t/τ)+B, (1)
where f(t) is the experimental data to be fit (e.g., optical power vs. time), t is time, τ is the ring-down time, and A and B are additional fitting parameters. The model of equation 1 is typically applied to a subset of the data points that exhibits a nearly pure exponential decay, and in such cases it is often convenient to set the time origin (i.e., t=0) to coincide with the time of the first data point in this subset. Although the fitted values of A and B are typically not significant, it is usually necessary to include both A and B in the model in order to obtain accurate results for τ. Note that if B were negligible in Eq. 1, the resulting model could be rapidly fit to the data points using a conventional linear least squares method. For nonnegligible B, the model of Eq. 1 has a nonlinear dependence on the parameters A, B, and τ which rules out the use of conventional linear least squares fitting methods. For this reason, general-purpose nonlinear curve fitting methods (e.g., the Levenberg-Marquardt method) have typically been employed to fit the model of Eq. 1 to ring-down data. Although the Levenberg-Marquardt method provides an accurate calculation of τ, the required computations are time-consuming. In addition, nonlinear curve fitting methods are typically iterative, so the time taken to generate a result may vary as the number of iterations required to obtain convergence varies. In cases where the computation time significantly affects instrument bandwidth (i.e. the rate at which measurements are performed), this variability in computation time is undesirable.

It is therefore an object of the present invention to provide for the rapid and accurate computation of the ring-down time from an analog ring-down signal derived from an optical resonator.

### SUMMARY

According to a first embodiment of the invention, the time required to calculate a ring-down time from sampled ring-down data is reduced by calculating a preliminary estimate of a set of fitting parameters (i.e., ring-down time, amplitude and background), which enables the use of a linear least squares method to fit the model of Equation 1 to ring down data. The preliminary estimate is obtained by averaging consecutive data points into “bins” and performing a linear least squares fit to the resulting binned signal. According to a second embodiment of the invention, the time required to obtain an accurate calculation of a ring-down time is reduced by performing a linear least squares fit using an estimate B1 of the background, then using the results of the fit to estimate the error in B1. The estimated error in B1 is then used to provide an improved estimate of the ring-down time. According to a third embodiment of the invention, the accuracy of a calculation of a ring-down time from sampled ring down data is improved by filtering an analog ring-down signal before sampling it. The filter is a low pass filter having a bandwidth related to a shortest expected ring-down time. In a fourth embodiment of the invention, the time required to perform a ring-down time calculation is reduced as in the first embodiment, and the accuracy of a ring-down calculation is improved as in the third embodiment. In this fourth embodiment, the parameters of the ring-down time calculation are preferably chosen to reduce a filter-induced error in the calculated ring-down time. In a fifth embodiment of the invention, the time required to perform a ring-down time calculation is reduced as in the second embodiment, and the accuracy of a ring-down calculation is improved as in the third embodiment. In this fifth embodiment, the parameters of the ring-down time calculation are preferably chosen to reduce filter-induced error in the calculated ring-down time.

### BRIEF DESCRIPTION OF THE DRAWINGS

FIG. 1 schematically shows a CRDS instrument.

FIG. 2 schematically shows the effect of a low pass filter on an analog ring-down signal.

FIG. 3a shows a plot of signal and noise vs. normalized filter bandwidth.

FIG. 3b shows a plot of a CRDS signal/noise ratio vs. normalized filter bandwidth.

FIG. 4 shows a plot of filter-induced bias vs. fitting window delay and normalized filter bandwidth.

FIG. 5 shows a plot of amplitude reduction vs. fitting window delay and normalized filter bandwidth.

FIG. 6 shows a flowchart of some preferred methods of calculating a ring-down time.

FIG. 7 shows a baseline of a typical analog ring-down signal.

FIG. 8 shows calculated plots of fractional error Δτ in a ring-down time estimate vs. background error ΔB, for various final fitting window durations.

FIG. 9 shows a calculated plot of the slope Δτ/ΔB at ΔB=0 vs. final fitting window duration.

FIG. 10 schematically shows how a ring-down signal is “binned”.

### DETAILED DESCRIPTION OF THE DRAWINGS

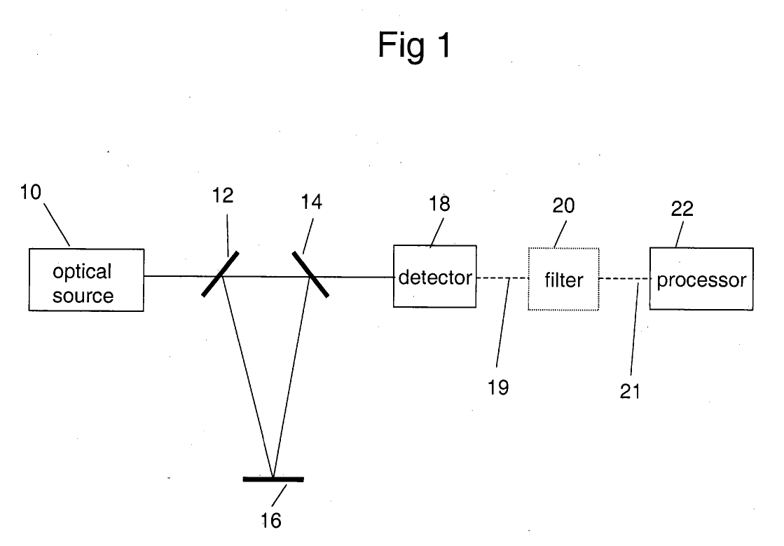

FIG. 1 schematically shows a CRDS instrument in accordance with the present invention. Optical source 10 emits radiation which is received by an optical resonator (i.e., the ring-down cavity) formed by mirror 12, mirror 14 and mirror 16. Typically optical source 10 is a laser (either continuous-wave or pulsed). In the example shown in FIG. 1, the ring-down cavity has three mirrors and is arranged as a ring resonator, although other resonators, such as linear, standing-wave resonators are also used in CRDS instruments. In the example of FIG. 1, light circulates within the ring-down cavity, and a fraction of the circulating optical power within the cavity is emitted through mirror 14 and is received by detector 18. Preferably source 10 and the ring-down cavity are arranged so that only one optical mode of the cavity is significantly coupled to the radiation emitted by source 10. In other words, it is preferred for the CRDS instrument to operate in a single mode.

To obtain ring-down data from the apparatus of FIG. 1, the coupling (or optical communication) between source 10 and the ring-down cavity (formed by mirrors 12, 14, and 16) is interrupted (e.g., by turning off or blocking the source, or by reducing the overlap of the source spectrum with the cavity mode spectrum). Various methods for interrupting the coupling between source 10 and the ring-down cavity are known in the art. Once source 10 is effectively decoupled from the ring-down cavity, the intensity of the source radiation trapped within the ring-down cavity decays in time. The time decay of the source radiation is exponential for a CRDS instrument operating in a single mode, with a time constant referred to as the ring-down time. The ring-down time depends on the total round trip loss within the resonator, including mirror losses and losses due to absorption and/or scattering by a sample (not shown on FIG. 1) placed within the ring-down cavity.

A fixed fraction (e.g., 0.1% if mirror 14 is substantially lossless and has a reflectivity of 99.9%) of the circulating optical power within the ring-down cavity is transmitted through mirror 14 and is received by detector 18. Thus mirror 14 acts as an output coupler for radiation circulating within the resonator. Detector 18 provides electrical signal 19 that is substantially proportional to the received optical power (i.e., detector 18 is linear). Typically, detector 18 is a semiconductor photodetector (e.g., a Silicon or InGaAs detector) chosen to be responsive at the wavelength of the source radiation. Electrical signal 19 provided by detector 18 exhibits an exponential decay having a time constant equal to the ring-down time, due to the linearity of detector 18 and the fixed fractional output coupling provided by mirror 14. Therefore, the ring-down time for the ring-down cavity can be measured by appropriate processing of electrical signal 19.

In the example of FIG. 1, electrical signal 19 is received and filtered by filter 20 (optional) which provides a filtered signal 21. Filter 20 (if present) is preferably a linear filter having a low pass response, with a bandwidth chosen by trading off noise reduction with signal distortion and/or reduction, as discussed subsequently. Filtered signal 21 (or electrical signal 19, if filter 20 is not present) is received by processor 22, which implements the calculation of the ring-down time from its input. The operation of processor 22 will be considered after discussing the effect of filter 20. Elements 18, 20 and 22 on FIG. 1 are to be understood in a block diagram sense. In other words, filter 20 includes the effect of electrical filtering (if any) performed by detector 18 after it performs the optical-to-electrical conversion, as well as the effect of electrical filtering (if any) performed by processor 22 on its analog input before the step of digitally sampling.

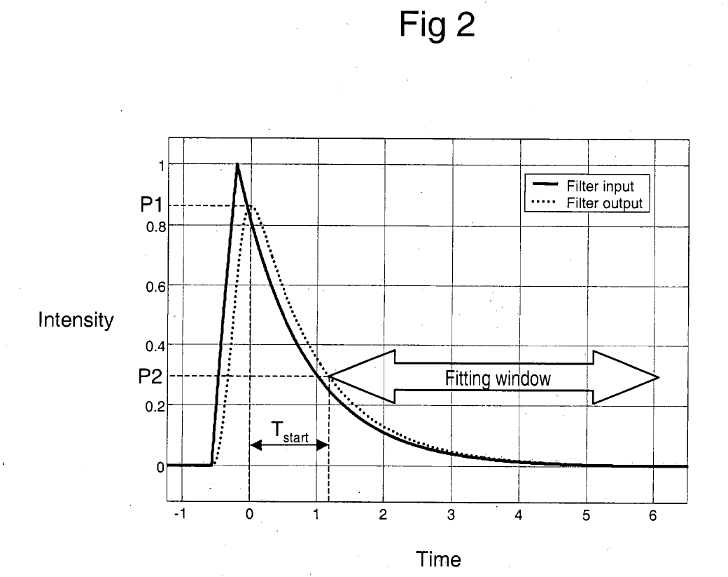

FIG. 2 schematically shows the effect of filter 20 on electrical signal 19. The solid line on FIG. 2 is electrical signal 19 (i.e., the input to filter 20) and the dotted line on FIG. 2 is filtered signal 21 (i.e., the output of filter 20). As seen on FIG. 2, the decay rate of the dotted line differs from the decay rate of the solid line. This difference in decay rates between input and output of filter 20 is referred to as filter-induced bias. Also shown on FIG. 2 is a fitting window, which is the portion of the curve that will used to calculate the ring-down time. A ring-down time calculation method usually includes a choice of fitting window, since not all parts of electrical signal 19 are exponentially decaying. Two points, P1 and P2, are shown on FIG. 2. P1 is the peak value of the filtered signal, and P2 is the value at the start of the fitting window.

Filter-induced bias is caused by the inability of filter 20 to instantaneously follow changes in its input. To reduce filter-induced bias, the bandwidth of filter 20 can be increased (so the filter output can follow its input more closely), and/or the fitting window can be chosen to exclude points near the peak of filtered signal 21 which are most severely affected by the transient response of filter 20. However, increasing the bandwidth of filter 20 increases the electrical noise present in filtered signal 21, and excluding points near the peak of filtered signal 21 from the fitting window decreases the signal in the fitting window. Both of these effects tend to degrade the signal to noise ratio of the signal in the fitting window. Therefore, it is useful to consider both filter-induced bias and signal to noise ratio (SNR) simultaneously in selecting a suitable filter bandwidth. Since signal, noise and filter-induced bias are all relevant for selecting a suitable filter bandwidth, it is helpful to simplify the analysis by fixing certain parameters to representative values.

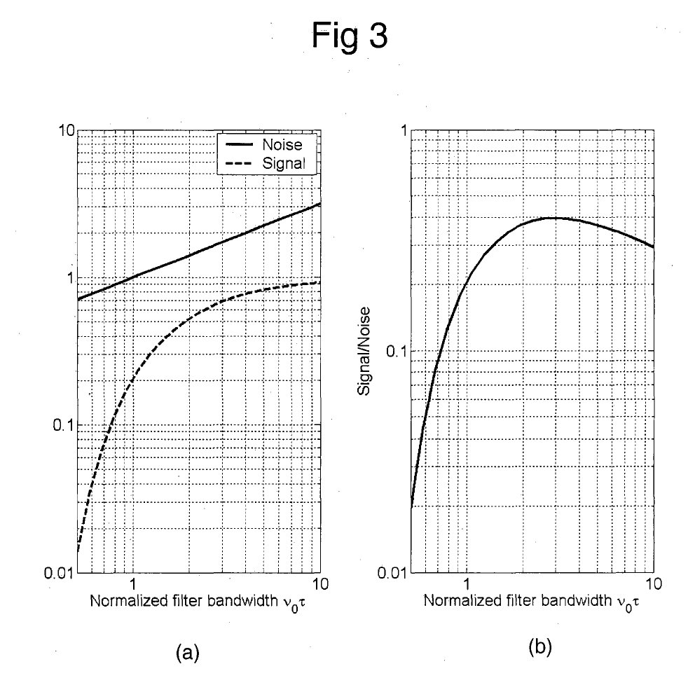

FIGS. 3a and 3b present the results of an exemplary filter bandwidth selection analysis. The input signal for these calculations rises to a peak value of unity, and decays exponentially from this peak value with known time constant τ, as shown on FIG. 2. As indicated in the discussion of Equation 1, t=0 is the time of the first point in the fitting window, so an alternate time scale t′ is introduced here that has its origin at the peak of the filtered signal. This input signal is (numerically) passed through a critically damped low pass second order filter (i.e., a filter having a transfer function H(s)=(2πν₀)²/(s+2πν₀)₂, where ν₀ is the 6 dB filter bandwidth). To simulate the operation of a ring-down time calculation method, a fitting window having a duration of 8τ is applied to the numerically filtered signal. The portion of the numerically filtered signal within the fitting window is sampled at a rate of 32 sample points per τ, and a nonlinear curve fitting method is applied to these sample points to calculate an estimate τₑₛₜ of the input decay time T. Filter-induced bias manifests as a difference between τₑₛₜ and τ.

The time span of the fitting window in the calculations of FIGS. 3a and 3b is Tₛₜₐᵣₜ≦t≦Tₛₜₐᵣₜ+8τ, where Tₛₜₐᵣₜ is the difference between the t origin and the t′ origin. In other words, Tₛₜₐᵣₜ is the time interval between the peak of the filtered signal and the start of the fitting window. Filter-induced bias tends to decrease as fitting window delay Tₛₜₐᵣₜ increases, since the time span covered by the fitting window is further from the t′=0 transient. It is preferred to reduce the effect of filter-induced bias to a level of little practical significance. Thus in the calculations of FIGS. 3a and 3b, the fractional bias (equal to |τₑₛₜ−τ|/τ) is held equal to 10⁻⁴ by varying the fitting window delay Tₛₜₐᵣₜ. In other words, filters of various bandwidths are compared based on the SNR they provide while simultaneously providing fractional bias=10⁻⁴.

The dotted line on FIG. 3a shows the signal level obtained in these calculations vs. normalized filter bandwidth=ν₀τ. As filter bandwidth increases, the signal level asymptotically approaches the input signal value of unity, since Tₛₜₐᵣₜ approaches 0. As filter bandwidth decreases, the signal level decreases, since Tₛₜₐᵣₜ increases to maintain the fractional bias=10⁻⁴. The solid line on FIG. 3a shows noise as a function of normalized filter bandwidth (assuming white noise). Due to the assumption of white noise at the filter input, the filter output noise amplitude is proportional to the square root of the filter bandwidth.

FIG. 3b shows a plot of the signal to noise ratio corresponding to the results of FIG. 3a. For ν₀ about equal to 3/τ the SNR is maximized. It has been found that for a wide variety of parameter values (e.g., number of points per time constant, fitting window duration, etc.) the optimal filter bandwidth (which maximizes SNR) is close to 3/τ. The filter bandwidth at which the SNR is maximized does not strongly depend on the functional form of the assumed noise spectral density. As a result of these considerations, it is preferred to select a filter bandwidth that satisfies 2/Tₛₕₒᵣₜ≦ν₀≦10/Tₛₕₒᵣₜ, where Tₛₕₒᵣₜ is the shortest ring-down time expected in normal operation of a given instrument. More preferably, the filter bandwidth is about 3/Tₛₕₒᵣₜ. Since filter-induced bias increases as ring-down time decreases, designing a CRDS instrument based on the shortest expected ring-down time ensures that the designed level of filter-induced bias is not exceeded for the range of ring-down times encountered in practice.

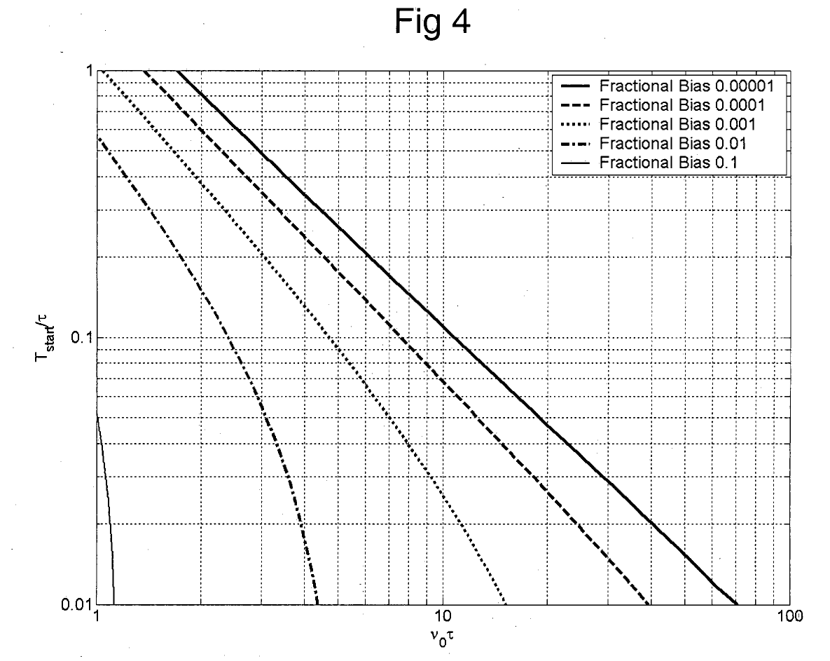

FIG. 4 shows a contour plot of fractional bias vs. Tₛₜₐᵣₜ and normalized bandwidth=ν₀τ. For ν₀=3/τ, it is seen that Tₛₜₐᵣₜ about equal to 0.35τ is required to obtain a fractional bias of 10⁻⁴. In practice, a preliminary estimate T1 of the time constant may be used to set Tₛₜₐᵣₜ. The delay Tₛₜₐᵣₜ is preferably between about 0.2T1 and about 0.5T1, and is more preferably about equal to 0.35T1.

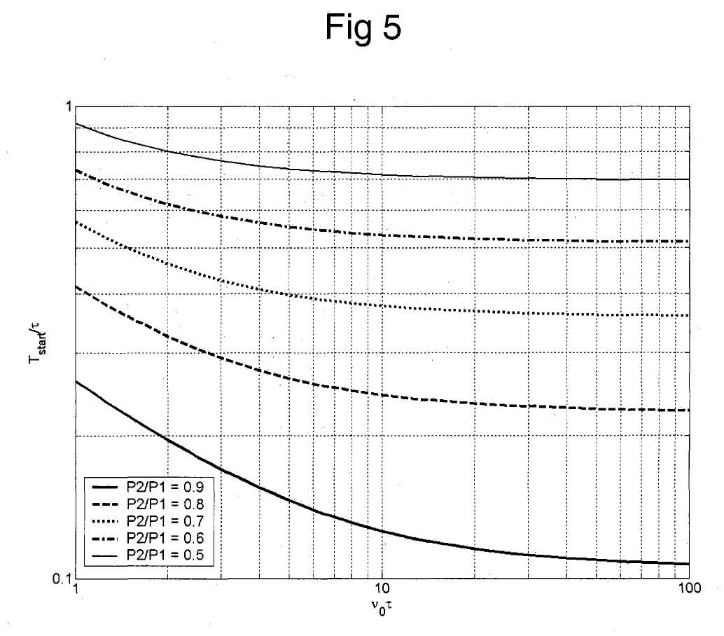

FIG. 5 shows a contour plot of the ratio of peak amplitude within the fitting window (e.g., point P2 on FIG. 2) to peak amplitude of filtered signal 21 (e.g., point P1 on FIG. 2) vs. Tₛₜₐᵣₜ and normalized bandwidth=ν₀τ. For ν₀=3/τ and Tₛₜₐᵣₜ=0.35τ, the ratio B/A is about 0.74. This result provides an alternate method of setting Tₛₜₐᵣₜ. More specifically, the fitting window can be selected to start at a data point which has a value which is a predetermined constant times the value of the largest data point. This largest data point is frequently used as a trigger point for the ring-down calculation, as discussed in more detail below. The predetermined constant is preferably between about 0.65 and about 0.85, and is more preferably about equal to 0.74.

The results of FIGS. 4 and 5 are based on the same parameters as the calculations of FIG. 3. Similar calculations can be done for other parameter values and/or other types of filter to provide results for Tₛₜₐᵣₜ/τ and/or predetermined constant P2/P1 corresponding to those given above for a second order critically damped filter.

Returning now to FIG. 1, processor 22 implements a method for calculating a ring-down time from filtered signal 21 (or electrical signal 19, if filter 20 is absent). Methods for calculating ring-down times are discussed in algorithmic terms, since implementation of such calculation methods in hardware and/or in software in processor 22 is known. Preferred calculation methods are digital, and include at least the following steps: 1) uniformly sampling an input analog ring-down signal (i.e., either electrical signal 19 on FIG. 1 (filter 20 absent) or filtered signal 21 on FIG. 1 (filter 20 present)); 2) identifying ring-down events within the ring-down table obtained by sampling; 3) constructing a digital ring-down signal having data points (tᵢ, f(tᵢ)) comprising a subset of the sampled data points having times which fall within a selected fitting window; and 4) calculating the ring-down time using a curve fitting method applied to the digital ring-down signal.

To reduce measurement time in cases where a filter is employed, it is preferred for the filter to be an analog filter, as shown on FIG. 1, which receives an analog signal from detector 19 and provides an analog filtered signal to processor 22. However, as can be expected from the discussion of FIGS. 3 through 5, a digital filter implemented within processor 22 can also be used to provide filtering of the ring-down signal. It is also possible to use both an analog filter and a digital filter to provide filtering of the ring-down signal. In general terms, the filter, if present, provides a filtered signal f(t). The filtered signal f(t) is either a continuous signal if the filtering is analog, or a discrete signal if some or all of the filtering is performed digitally. The above discussion of preferable filter bandwidth applies in either case.

The step of sampling an analog ring-down signal entails the creation of a table having a multiplicity of data points, each point having a time and a value, where adjacent points in the table are separated in time by a sampling time Tₛ. The sampling time Tₛ is typically chosen to be significantly smaller than (i.e., preferably less than one tenth of) the shortest ring-down time expected in practice, so that the table of sampled data points provides a faithful replica of the analog input. For example, in the calculation of FIGS. 3 through 5, the sampling time Tₛ is equal to τ/32. The value of each data point is preferably the value of electrical signal 19 (if filter 20 is absent) or the value of filtered signal 21 (if filter 20 is present) at the time of the data point. Alternatively, the value for each data point can be any other quantity that is proportional to the light intensity emitted from the ring-down cavity. In practice, the table can be any suitable data structural arrangement, in hardware and/or in software, that provides an association between time and value for each data point.

Once this ring-down table is generated, the next step is to identify ring-down events within the table. As indicated on FIG. 2, ring-down events will manifest as a peak followed by a decay. A suitable method for finding a ring-down event is to look for a trigger data point which a) is a local maximum (i.e. it has a value which is greater than or equal to the values of data points which are time-adjacent to it, and b) has a value which is above a predetermined upper threshold. The upper threshold is chosen to be below the typical ring-down peak values calculated (or measured) for a CRDS instrument, while also being above the typical noise level calculated (or measured) for a CRDS instrument. By setting the upper threshold in this manner, peaks in the ring-down table which are above the upper threshold are processed as ring-down events, while peaks that fall below the upper threshold are not processed as ring-down events, since they are attributed to noise.

It is preferred to obtain an estimate of the ring-down time τ for use in selecting the fitting window. This preliminary estimate of the ring-down time, referred to as T1, need not be a highly accurate estimate of the ring-down time τ, and is preferably obtained with a simple and rapid calculation. A suitable method for calculating T1 is to average the time separation of data points at times later than the time of the trigger data point that differ in value by a predetermined ratio. For example, let t1, t2, t3 . . . be the times at which the ring-down signal falls to e^{-1/2}, e⁻¹, e^{-3/2} . . . of its maximum value. Then t2−t1, t3−t2 etc. are all estimates of τ/2, and averaging these time intervals (and multiplying by 2) is a suitable method for computing the estimate T1. In this example, the predetermined ratio is e^{-1/2} (or, equivalently, e^{1/2}), and T1 is equal to twice the average time separation of points which have values differing by this ratio. A predetermined ratio of e^{-1/2} has been found suitable in practice, although the invention may be practiced with other predetermined ratios.

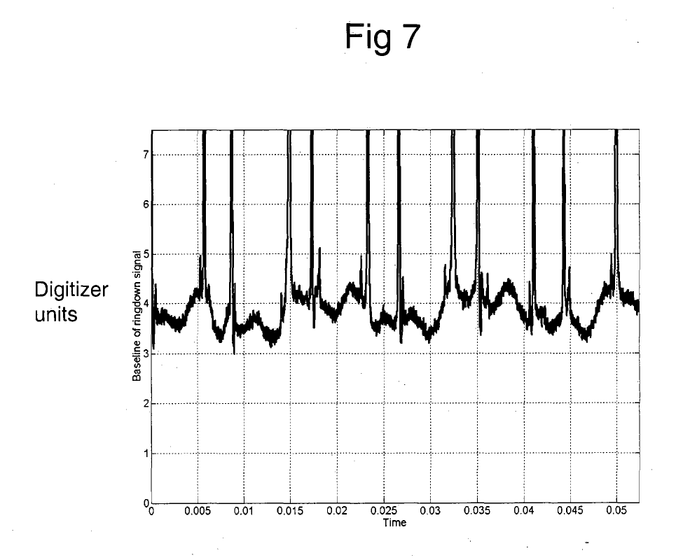

The duration of the fitting window is preferably between about 5T1 and about 15T1, and is more preferably about equal to 10T1, because a good estimate of the background (i.e., B in Equation 1) is typically needed in order to accurately determine τ from the measured data. The background B is usually not the same for all ring-down events (e.g., as shown on FIG. 7), so the ring-down time calculation must account for B for each ring-down event.

The start time Tₛₜₐᵣₜ of the fitting window is preferably determined in either of two ways, both based on the discussion of FIGS. 2 through 5. The first method is to set Tₛₜₐᵣₜ equal to the time of the trigger point plus a certain fraction of the estimate T1 (e.g., 0.35 T1 corresponding to the above examples). The second method is to set Tₛₜₐᵣₜ to be the time of the first data point after the trigger data point that takes on a value that is less than (or less than or equal to) a predetermined fraction of the value of the trigger data point (e.g., a predetermined fraction of about 0.74 corresponding to the above examples). The result of either method is that Tₛₜₐᵣₜ is set to a value which ensures the filter-induced bias is less than or equal to a design value (e.g., fractional bias≦10⁻⁴ in the above examples). As indicated above, the analysis discussed in FIGS. 2 through 5 can be performed for filters other than a critically damped second order filter, and/or for parameters other than were used in the above examples. Such analysis provides a basis for selecting the fitting window depending on the filter parameters (e.g., filter type and bandwidth). The construction of the digital ring-down signal is complete once a fitting window has been selected, preferably in accordance with the preceding discussion.

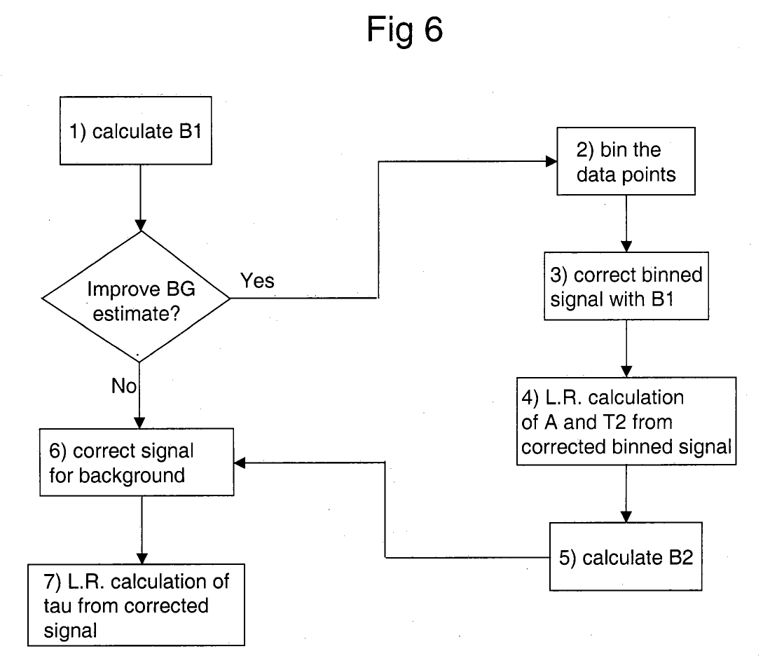

FIG. 6 provides a partial flowchart of some preferred ring-down time calculation methods, giving the steps in the methods that follow the selection of the fitting window. In other words, a digital ring-down signal having data points (tᵢ, f(tᵢ)) for times which fall within a suitable fitting window is defined at this point in the ring-down time calculation methods. The “yes-no” branch on FIG. 6 indicates a choice that can be made by a practitioner of the invention, based on the requirements of the relevant CRDS application. For example, the “yes” path is more appropriate for applications which require improved accuracy of the ring-down time estimate and can tolerate a small increase in the measurement time, while the “no” path is more appropriate for applications which require reduced measurement time and can tolerate a small reduction in measurement accuracy.

Step 1 on FIG. 6 is to calculate a first estimate, B1, of the background of the ring-down event. It is desirable for this computation to be simple and rapid, and a suitable method is to average a portion of the “tail” of the ring-down event. A preferred range over which to average to calculate B1 is the range of t from about 8T1 to about 10T1. The systematic error in this estimate of the background can be estimated by averaging the right side of

$$\begin{matrix}Equation 1 \text{:} & \\ B1 = \frac{1}{{t}_{b} - {t}_{a}} {\int }_{{t}_{a}}^{{t}_{b}} A exp ( - t / τ ) + B ⅆ t = B + A \frac{{ⅇ}^{- {T}_{a}} - {ⅇ}^{- {T}_{b}}}{{T}_{b} - {T}_{a}} , & ( 2 )\end{matrix}$$

where Tₐ=tₐ/τ and T_{b}=t_{b}/τ. Thus the averaging procedure used to obtain the background estimate B1 overestimates the true background B, and this error is approximately given by the second term of Equation 2. Assuming T1 is approximately equal to τ, the fractional error ΔB=(B1−B)/A incurred by averaging from 8T1 to 10T1 is about 0.014%. Ranges other than about 8T1 to about 10T1 may also be used to estimate B1 in practicing the invention. FIG. 7 shows the baseline of a typical ring-down signal. The peak of each ring-down event is at roughly 2000 digitizer units (i.e., far above the range of the plot), and the peak-to-peak variation in background level for the ring-down events is roughly 1 digitizer unit. The data shown on FIG. 7 was sampled at 10 MHz and then subjected to a 501 point moving average, which is the reason the noise is substantially less than one digitizer unit.

The next step on FIG. 6 is a decision whether or not to improve the estimate of the background. For now, we consider the case where the background estimate is not improved, so the calculation proceeds to step 6 on FIG. 6. In step 6, the signal is corrected for the background. More specifically, the estimate B1 of the background value is subtracted from the values of all data points in a selected final fitting range within the fitting window, providing a corrected digital ring-down signal. The range of t from about zero to about 4T1 is a preferred final fitting range, for reasons which are given later.

Subtracting off the background allows for the use of a significantly simpler model in fitting the data. In particular, a linear model can be employed. When the model of Equation 1 is applied to f(t) data and an estimate of B is available (e.g., B1 as calculated above), a rearrangement of Equation 1 gives:
In[f(t)−B1]=InA−t/τ. (3)
Since the left side of Equation 3 is known, the unknown fitting parameters are A and τ on the right side of Equation 3. The model of Equation 3 has a linear dependence on the parameters InA and τ, which allows the use of conventional linear least squares curve fitting methods which require less computation time than nonlinear curve fitting methods (e.g., the Levenberg-Marquardt method).

It is preferred to employ a weighted linear least squares method, which provides estimates A* and τ* of the parameters A and τ which minimize the quantity
Σ[(zᵢ−z(A*,τ*))yᵢ]² (4)
where yᵢ=f(tᵢ)−B1, zᵢ=In(yᵢ), z(A*,τ*)=InA*−tᵢ/τ*, tᵢ=iTₛ where Tₛ is the sampling time, and the sum runs over all data points in the final fitting range. Here f(tᵢ) is the digital ring-down signal defined above, and yᵢ is a corrected digital signal. The factor yᵢ in Equation 4 is the weighting factor. In other words, the least squares method of Equation 4 is weighted according to yᵢ, the values of the corrected digital signal. We assume the data point values yᵢ all have roughly the same uncertainty (e.g., as would be provided by additive noise). With this assumption, and further assuming low noise (i.e. standard deviation<<mean, for each data point value yᵢ), the standard deviation of the logarithm data points zᵢ is proportional to 1/yᵢ. In other words, data points having smaller values have more uncertain logarithms. For this reason, the weighted least squares method of Equation 4 is preferred, since it appropriately reduces the influence of small data points on the overall fit, and provides significantly enhanced accuracy. Although the weighted least squares method of Equation 4 is preferred, unweighted least squares methods may also be employed to practice the invention.

The selection of a preferred final fitting range of t from about zero to about 4T1 is based on several considerations. Although increasing the range of the final fitting window decreases the uncertainty in fitted parameters, this increase is asymptotic and a final fitting window that is four time constants long provides an uncertainty in τ that is only 1.01 times the asymptotic uncertainty in τ. Since e⁻⁴ is about 0.02, and the relative standard deviation of data points (i.e., σ/Λ, where σ is the standard deviation) is typically on the order of 0.001, the low noise assumption is valid within the preferred final fitting range. Finally, small data points from the tail of the ring-down event may give rise to negative values of yᵢ which have undefined logarithms. Although it is possible to deal with the logarithm problem by omitting points with negative yᵢ from the fit, or by replacing negative values of yᵢ with a small positive constant, it is preferable to avoid this issue by restricting the final fitting range as indicated. However, the invention may be practiced with final fitting ranges other than the above preferred range.

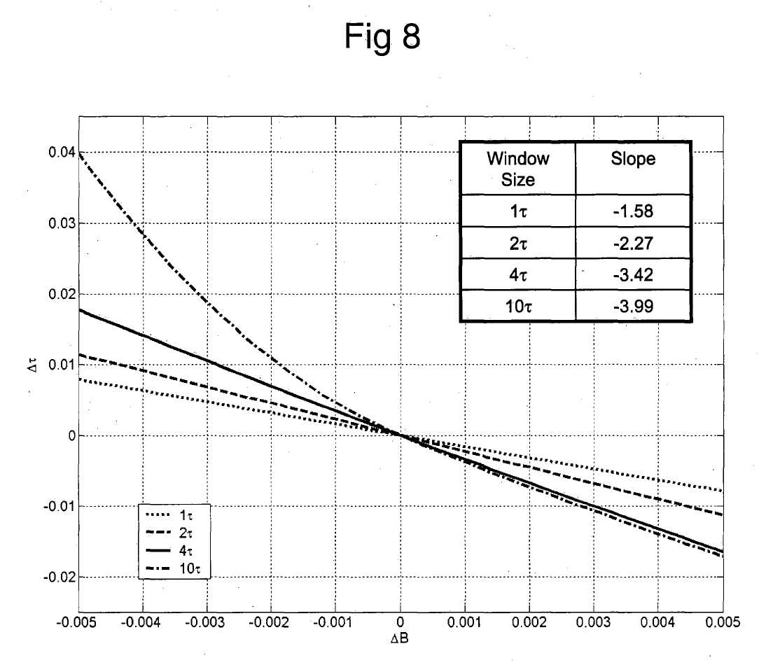

The accuracy of this method (i.e., the “no” path on FIG. 6) is limited by the accuracy of the B1 estimate. Recall that ΔB is roughly 0.014% if B1 is obtained by averaging the tail of the ring-down event from about 8T1 to about 10T1. The fractional error Δτ=(τ*−τ)/τ is a function of ΔB, as shown on FIG. 8 for various final fitting ranges. The inset on the plot of FIG. 8 provides a table of the slope of Δτ(ΔB) at ΔB=0 for several final fitting window durations. The error in B1 is typically low enough (e.g., 0.014% in the example) to permit the use of this linear approximation. For a final fitting range from 0 to 4 T1, the fractional error in the background is amplified by a factor of roughly 3.4 when it enters the estimate of the ring-down time. Thus by using the B1 estimate for the background, the accuracy of τ* is limited to about 0.05%. For some CRDS applications, this accuracy is sufficient, and in such cases the above method which provides the estimate τ* is a suitable method for calculating the ring-down time.

Some CRDS applications require greater accuracy in the τ estimate than is provided by the-above method. Various methods are suitable for improving the τ estimate. For example, it is possible to use the A* and τ* estimates obtained above to estimate the second term in Equation 2, which allows the computation of a more accurate estimate of the background. The linear least squares calculation can then be repeated using this improved background estimate to provide a more accurate estimate of τ. While this approach for improving accuracy is straightforward, it has the disadvantage that two least squares fits are required, which undesirably increases computation time.

Two alternative and preferred methods for improving the accuracy of the τ estimate have been developed which increase computation time by only a small fraction of the time required for a linear least squares fit to all the points in the final fitting window. The first method uses the τ* estimate in order to calculate the error in B1, which is used to calculate the error in τ*, which in turn enables the calculation of a improved estimate of τ. The second method follows the “yes” path on FIG. 6, and entails the calculation of an improved estimate of the background B2 which is used to correct the data points before performing a weighted linear least squares fit to determine τ*. The τ* provided by this second method has improved accuracy due to a reduced error in B2 as compared to B1. These two methods for improving accuracy will be discussed in turn.

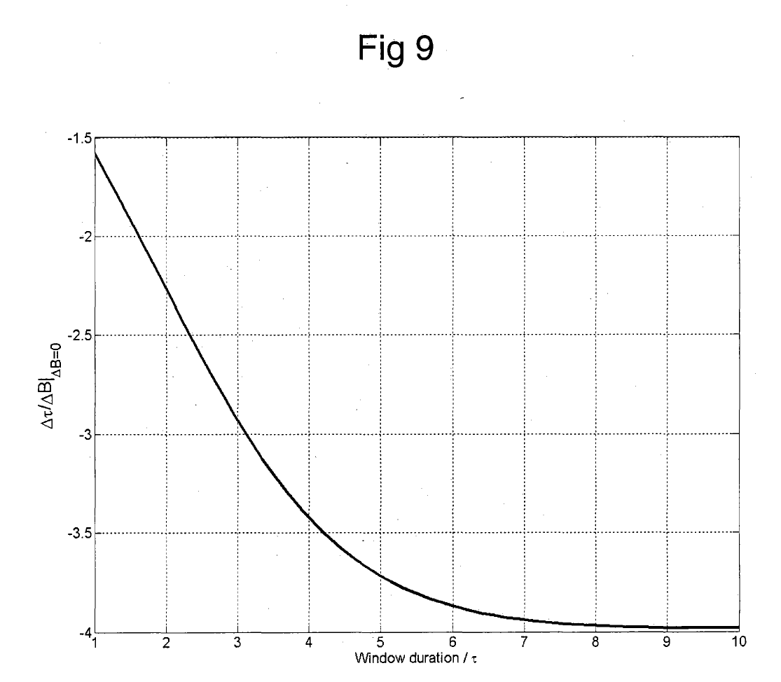

A first preferred method for improving accuracy begins with the steps given in the “no” path on FIG. 6. After these steps are completed, a τ* estimate is available that has an accuracy of about 0.05%, as indicated above. Since τ* is a more accurate estimate of the ring-down time than T1, it can be used to calculate the effect of the error in B1. The second term on the right side of Equation 2 can be estimated by setting τ=τ*, and setting tₐ′ and t_{b}′ to the same values that were used in the calculation of B1 (e.g., tₐ′=8T1 and t_{b}′=10T1 for the preferred B1 averaging range). This calculation provides an estimate of the fractional error ΔB. Both the magnitude and sign of ΔB are known, since B1 is always an overestimate of B. FIG. 9 shows a plot of the slope of Δτ(ΔB) at ΔB=0 as a function of final fitting window duration, where the final fitting window duration is normalized to τ. The result of FIG. 9 enables a correction to be made for the difference (if any) between T1 and τ*. For example, if τ* turns out to be equal to 0.8 T1, and a final fitting window from 0 to 4T1 is selected, then the duration of this final fitting window is 5τ*, and the slope m(5) at duration=5τ on FIG. 9 is the relevant slope. Continuing this example, we have Δτ=m(5)ΔB, which can be estimated since both factors on the right side are known. Further continuing the example, the improved estimate τ** of the ring-down time is given by τ**=τ*/(1+Δτ). In other words, the error Δτ is estimated and then used to provide a correction to the first estimate τ*. Note that a second least squares fit is not required to obtain τ**. In practice, the m(ΔB) curve of FIG. 9 is preferably stored in processor 22 in a suitable form (e.g., a lookup table) for rapid use in calculations. The calculations required to generate FIG. 9 only have to be performed once. It is not necessary to perform such calculations for each ring-down event.

A second preferred method for improving accuracy follows the “yes” path on FIG. 6. Step 1 of this method is the computation of the background estimate B1 according to the preceding discussion. The overall purpose of steps 2 through 4 is to obtain estimates of A and τ that are sufficiently accurate to enable the computation of an improved background estimate B2 which is more accurate than B1. Step 2 is the construction of a binned ring-down signal Yⱼ given by

$${Y}_{j} = \frac{1}{N} {\sum }_{i = jN}^{( j + 1 ) N - 1} f ( {t}_{i} ) , \qquad ( 5 )$$

where N is the number of data points in each bin, and i runs over all data points in a selected binning window. A preferable binning window is the range of t from about 0 to about 5T1, and a preferable number of bins N_{bin} is ten, which implies N=Nₜₒₜ/10, where Nₜₒₜ is the number of points in the range of t from about 0 to about 5T1. Thus each bin preferably has a duration T_{bin} of about 0.5T1. With these selections, the index j in Equation 5 runs from 0 to 9. As seen from Equation 5, the binned ring-down signal data points Yⱼ are averages of sections of the digital ring-down signal f(tᵢ). While the above parameters for the binned signal (i.e. N_{bin} about equal to 10 and T_{bin} about equal to 0.5 T1) are preferred, the invention may be practiced with other binned signal parameters.

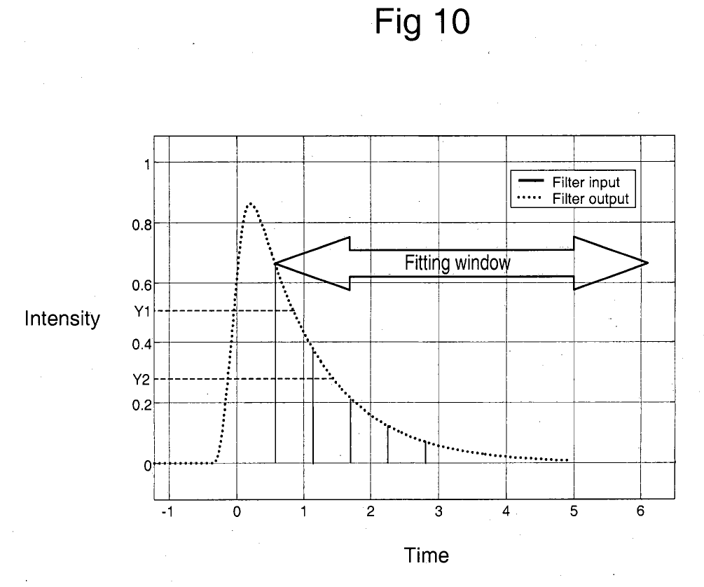

FIG. 10 schematically indicates how the binning of Equation 5 is implemented. The dotted line is the digital ring-down signal to be binned, the solid vertical lines are the boundaries of the bins, and the values of the first two points, Y1 and Y2, of the binned signal are shown on the vertical axis. Other points of the binned signal are omitted for clarity. As indicated above, Y1 and Y2 are equal to the average value of their respective bins.

The binned ring-down signal is exponentially decaying with time constant τ_{bin}=τ, background B_{bin}=B, and amplitude A_{bin} given by

$${A}_{bin} = A exp [ - \frac{( N - 1 ) {T}_{s}}{2 τ} ] \frac{sinh ( \frac{{NT}_{s}}{2 τ} )}{sinh ( \frac{{T}_{s}}{2 τ} )} , \qquad ( 6 )$$

where Tₛ is the sampling time (i.e., the separation in time between adjacent data points f(tᵢ)). These results are obtained by substituting Equation 1 into Equation 5 and evaluating the sum.

Step 3 of the second preferred method for improving accuracy is the subtraction of the background estimate B1 from the binned ring-down signal Yⱼ. Step 4 is the calculation of a weighted linear least squares fit, as discussed above, to the corrected binned data points Yⱼ−B1. This calculation provides estimates for A_{bin} and τ_{bin}, the amplitude and time constant respectively of the binned ring-down signal. The above relations are then used to obtain corresponding estimates A2 and T2 for A and τ respectively.

In step 5, the estimates A2 and T2 are used in the calculation of an improved background estimate B2. First, a background determination window is selected. The range of t from about 5T2 to about 10T2 is preferable, although other ranges may be used to practice the invention. The background estimate B2 is given by

$$B2 = ( \frac{1}{{k}_{2} - {k}_{1} + 1} {\sum }_{k = {k}_{1}}^{{k}_{2}} f ( {kT}_{s} ) ) - \frac{A2}{{k}_{2} - {k}_{1} + 1} [ \frac{{ⅇ}^{- ( {k}_{2} + 1 ) {T}_{s} / T2} - {ⅇ}^{- {k}_{1} {T}_{s} / T2}}{{ⅇ}^{- {T}_{s} / T2} - 1} ] , \qquad ( 7 )$$

where k₁ is the index of the first data point in the background determination window and k₂ is the index of the last data point in the background determination window. The result of Equation 7 is obtained by discretely averaging the model of Equation 1, solving for the background B, and setting B2 equal to this estimate of B.

Step 6 of the second preferred method for improving accuracy is as discussed above, except that the background estimate B2 from Equation 7 is used instead of background estimate B1. Step 7 is also as discussed above, and the results A* and τ* of the weighted linear least squares calculation are the final results for this method. The use of the B2 background estimate instead of B1 provides improved accuracy. The calculations in steps 2 through 5 of this method together require only a small fraction of the time required for a linear least squares fit to all the points in the final fitting window. The reason the computation time for steps 2 through 5 is so low is that the least squares fit used to obtain A2 and T2 is based on the binned ring-down signal, which has significantly fewer data points (e.g., 10 in a preferred example given above) than the original unbinned signal (e.g., roughly 300, assuming a fitting window duration of roughly 10 time constants and roughly 30 data points per time constant). The time required to perform a linear least squares fit increases significantly as the number of data points increases, so the least squares calculation of step 4 is much less time consuming than the least squares calculation of step 7.

The second preferred method for increasing the accuracy of the ring-down time calculation described above has been compared to the Levenberg-Marquardt method in practice. In this comparison, the second preferred method of the present invention provides results that are as accurate as the results provided by the Levenberg-Marquardt method, but requires only about one tenth of the computation time required by the Levenberg-Marquardt method.

Two main aspects of the invention have been discussed above: 1) the use of a filter having a selected bandwidth to filter the ring-down signal, especially in combination with a selection of the fitting window that provides a filter-induced bias that is below a selected value; and 2) rapid methods of computing the ring-down time from measured ring-down data in combination with methods for improving the accuracy of the ring-down time calculation without significantly increasing computation time. Preferably, the ring-down time calculation method will utilize both of these aspects of the invention, however, it is possible to utilize either procedure independently.

1. A method for calculating a ring-down time from a ring-down signal derived from a cavity ring-down spectroscopy instrument, wherein the ring-down time is responsive to conditions within an optical resonator of the instrument, the method comprising:
a) selecting a low pass filter having a bandwidth equal to X/Tₛₕₒᵣₜ where Tₛₕₒᵣₜ is a shortest expected ring-down time and X is a predetermined constant in a range from about 2 to about 10;
b) passing the ring-down signal through the filter to provide a filtered signal f(t), where t is time;
c) constructing a digital ring-down signal comprising data points (tᵢ, f(tᵢ)) having values f(tᵢ), wherein ti denotes a set of points substantially uniformly spaced in time which fall within a selected fitting window; and
d) calculating the ring-down time using a curve fitting method applied to the digital ring-down signal.

2. The method of claim 1, wherein said low pass filter is an analog filter.

3. The method of claim 1, wherein said low pass filter is a digital filter.

4. The method of claim 1, where X is about 3.

5. The method of claim 1, further comprising calculating an estimate T1 of the ring-down time by averaging the time separation of data points of said filtered signal which differ in value by a predetermined ratio.

6. The method of claim 5, wherein said predetermined ratio is substantially equal to e\hat{ }(1/2).

7. The method of claim 5, wherein a duration of said fitting window is in a range from about 5T1` to about 15T1.

8. The method of claim 7, where said duration is about 10T1.

9. The method of claim 1, further comprising the step of searching said filtered signal for a trigger data point having a value which is a local maximum and which exceeds a predetermined upper threshold.

10. The method of claim 9, further comprising the step of calculating an estimate T1 of the ring-down time by averaging the time separation of data points of said digital ring-down signal which differ in value by a predetermined ratio.

11. The method of claim 10, wherein a time interval between said trigger data point and a first data point of said digital ring-down signal is in a range from about 0.2T1 to about 0.5T1.

12. The method of claim 11, where said time interval is about 0.35T1.

13. The method of claim 9, wherein an earliest point of said digital ring-down signal is selected to be the first point of said filtered signal following said trigger data point whose value is less than Y times the value of said trigger data point, where Y is a predetermined constant in a range from about 0.65 to about 0.85.

14. The method of claim 13, where Y is about 0.74.

15. The method of claim 5, wherein said curve fitting method comprises:
f) calculating a first estimate B1 of a background level by averaging the values of data points in a background range of said digital ring-down signal;
g) constructing a binned signal by subdividing said digital ring-down signal into a predetermined number N_{bin} of adjacent sections, each having a duration T_{bin}, and averaging the values of data points within each of the sections;
h) calculating a corrected binned signal having values which are substantially equal to the values of said binned signal minus B1;
i) calculating an estimate A2 of an amplitude and an improved estimate T2 of the ring-down time using weighted linear regression of a logarithm of the values of said corrected binned signal;
j) calculating a second estimate B2 of the background level which is substantially equal to the average of the values of the data points of said digital ring-down signal within a background determination window minus the average of an exponential with amplitude A2 and time constant T2 within the background determination window;
k) calculating a corrected digital signal having values which are substantially equal to the values of said digital ring-down signal minus B2 within a final fitting window; and
l) calculating said ring-down time using weighted linear regression of a logarithm of the values of said corrected digital signal.

16. The method of claim 15, wherein said background range is from about 8T1 to about 10T1.

17. The method of claim 15, wherein said duration T_{bin} is substantially equal to 0.5T1.

18. The method of claim 15, wherein said predetermined number N_{bin} is about 10.

19. The method of claim 15, wherein said background determination window is from about 5T1 to about 10T1.

20. The method of claim 15, wherein said final fitting window is from about 0 to about 4T2.

21. The method of claim 15, wherein the weighted linear regression of step i is weighted according to the values of said corrected binned signal.

22. The method of claim 15, wherein the weighted linear regression of step 1 is weighted according to the values of said corrected digital signal.

23. The method of claim 5, wherein said curve fitting method comprises:
f) calculating an estimate B1 of a background level by averaging the values of data points in a background range of said digital ring-down signal;
g) calculating a corrected digital signal having values which are substantially equal to the values of said digital ring-down signal minus B1 within a final fitting window;
h) calculating an estimate τ* of the ring-down time using weighted linear regression of a logarithm of the values of said corrected digital signal;
i) calculating an estimated error ΔB in the estimate B1 of the background using the estimate τ*;
j) calculating an estimated error Δτ in the estimate τ* using the estimated error ΔB and the estimate τ*; and
k) calculating said ring-down time using the estimate τ* and the estimated error Δτ.

24. The method of claim 23, wherein said background range is from about 8T1 to about 10T1.

25. The method of claim 23, wherein said final fitting window is from about 0 to about 4T2.

26. The method of claim 23, wherein the earliest point in said fitting window is at t=0, and wherein said background window extends from t=ta to t=tb, and wherein ΔB is calculated according to ΔB=τ* (exp(−ta/τ*)−exp(−tb/τ*))/(tb−ta).

27. The method of claim 23, wherein the step of calculating the ring-down time comprises setting the ring-down time substantially equal to τ*/(1+Δτ).

28. The method of claim 23, wherein the weighted linear regression of step h is weighted according to the values of said corrected digital signal.

29. A method for calculating a ring-down time from a ring-down signal derived from a cavity ring-down spectroscopy instrument, wherein the ring-down time is responsive to conditions within an optical resonator of the instrument, the method comprising:
a) generating a ring-down table having a multiplicity of data points, each point having a time and a value, by substantially uniformly time sampling said ring-down signal;
b) calculating an estimate T1 of the ring-down time by averaging the time separation of data points within said table which differ in value by a predetermined ratio;
c) constructing a digital ring-down signal comprising consecutive data points in said table which fall within a selected fitting window;
d) calculating a first estimate B1 of a background level by averaging the values of data points in a background range of said digital ring-down signal;
e) constructing a binned signal by subdividing said digital ring-down signal into a predetermined number N_{bin} of adjacent sections, each having a duration T_{bin}, and averaging the values of data points within each of the sections;
f) calculating a corrected binned signal having values which are substantially equal to the values of said binned signal minus B1;
g) calculating an estimate A2 of an amplitude and an improved estimate T2 of the ring-down time using weighted linear regression of a logarithm of the values of said corrected binned signal;
h) calculating a second estimate B2 of the background level which is substantially equal to the average of the values of the data points of said digital ring-down signal within a background determination window minus the average of an exponential with amplitude A2 and time constant T2 within the background determination window;
i) calculating a corrected digital signal having values which are substantially equal to the values of said digital ring-down signal minus B2 within a final fitting window; and
j) calculating said ring-down time using weighted linear regression of a logarithm of the values of said corrected digital signal.

30. The method of claim 29, wherein a duration of said fitting window is in a range from about 5T1 to about 15T1.

31. The method of claim 30, where said duration is about 10T1.

32. The method of claim 29, wherein said background range is from about 8T1 to about 10T1.

33. The method of claim 29, wherein said duration T_{bin} is substantially equal to 0.5T1.

34. The method of claim 29, wherein said predetermined number N_{bin} is about 10.

35. The method of claim 29, wherein said background determination window is from about 5T1 to about 10T1.

36. The method of claim 29, wherein said final fitting window is from about 0 to about 4T2.

37. The method of claim 29, wherein the weighted linear regression of step g is weighted according to the values of said corrected binned signal.

38. The method of claim 29, wherein the weighted linear regression of step j is weighted according to the values of said corrected digital signal.

39. A method for calculating a ring-down time from a ring-down signal derived from a cavity ring-down spectroscopy instrument, wherein the ring-down time is responsive to conditions within an optical resonator of the instrument, the method comprising:
a) generating a ring-down table having a multiplicity of data points, each point having a time and a value, by substantially uniformly time sampling said analog ring-down signal;
b) calculating an estimate T1 of the ring-down time by averaging the time separation of data points within said table which differ in value by a predetermined ratio;
c) constructing a digital ring-down signal comprising consecutive data points in said table which fall within a selected fitting window;
d) calculating an estimate B1 of a background level by averaging the values of data points in a background range of said digital ring-down signal;
e) calculating a corrected digital signal having values which are substantially equal to the values of said digital ring-down signal minus B1 within a final fitting window;
f) calculating an estimate τ* of the ring-down time using weighted linear regression of a logarithm of the values of said corrected digital signal;
g) calculating an estimated error ΔB in the estimate B1 of the background using the estimate τ*;
h) calculating an estimated error Δτ in the estimate τ* using the estimated error ΔB and the estimate τ*; and
i) calculating said ring-down time using the estimate τ* and the estimated error Δτ.

40. The method of claim 39, wherein a duration of said fitting window is in a range from about 5T1 to about 15T1.

41. The method of claim 40, where said duration is about 10T1.

42. The method of claim 39, wherein said background range is from about 8T1 to about 10T1.

43. The method of claim 39, wherein said final fitting window is from about 0 to about 4T2.

44. The method of claim 39, wherein the earliest point in said fitting window is at t=0, and wherein said background window extends from t=ta to t=tb, and wherein ΔB is calculated according to ΔB=τ*(exp(−ta/τ*)−exp(−tb/τ*))/(tb−ta).

45. The method of claim 39, wherein the step of calculating the ring-down time comprises setting the ring-down time substantially equal to τ*/(1+Δτ).

46. The method of claim 39, wherein the weighted linear regression of step f is weighted according to the values of said corrected digital signal.

47. A cavity ring-down instrument comprising:
a) an optical source;
b) a ring-down cavity in optical communication with the source;
c) a detector positioned to receive radiation emitted from the ring-down cavity, the detector providing a ring-down signal;
d) a filter which receives the ring-down signal and provides a filtered signal f(t) where t is time, wherein the filter has a bandwidth substantially equal to X/Tₛₕₒᵣₜ, where Tₛₕₒᵣₜ is a shortest expected ring-down time and X is a predetermined constant substantially in a range from about 2 to about 10; and
e) a processor, wherein the processor constructs a digital ring-down signal comprising data points (tᵢ, f(tᵢ)) having values f(tᵢ), wherein tᵢ denotes a set of points substantially uniformly spaced in time which fall within a selected fitting window, and wherein the processor calculates a ring-down time using a curve fitting method applied to the digital ring-down signal.

48. A cavity ring-down instrument comprising:
a) an optical source;
b) a ring-down cavity in optical communication with the source;
c) a detector positioned to receive radiation emitted from the ring-down cavity, the detector providing an analog ring-down signal; and
d) a processor, wherein the processor substantially uniformly samples the analog ring-down signal to generate a ring-down table having a multiplicity of data points, each point having a time and a value, and wherein the processor constructs a digital ring-down signal comprising consecutive data points in the ring-down table which lie within a selected fitting window, and wherein the processor calculates an estimate T1 of a ring-down time by averaging the time separation of data points within said fitting window which differ in value by a predetermined ratio, and wherein the processor calculates a first estimate B1 of a background level by averaging the values of data points in a background range of said digital ring-down signal, and wherein the processor constructs a binned signal by subdividing said digital ring-down signal into a predetermined number N_{bin} of adjacent sections, each having a duration T_{bin}, and averaging the values of data points within each of the sections, and wherein the processor calculates a corrected binned signal having values which are substantially equal to the values of said binned signal minus B1, and wherein the processor calculates an estimate A2 of an amplitude and an improved estimate T2 of the ring-down time using weighted linear regression of a logarithm of the values of said corrected binned signal, and wherein the processor calculates a second estimate B2 of the background level which is substantially equal to the average of the values of the data points of said digital ring-down signal within a background determination window minus the average of an exponential with amplitude A2 and time constant T2 within the background determination window, and wherein the processor calculates a corrected digital signal having values which are substantially equal to the values of said digital ring-down signal minus B2 within a final fitting window, and wherein the processor calculates said ring-down time using weighted linear regression of a logarithm of the values of said corrected digital signal.

49. A cavity ring-down instrument comprising:
a) an optical source;
b) a ring-down cavity in optical communication with the source;
c) a detector positioned to receive radiation emitted from the ring-down cavity, the detector providing an analog ring-down signal; and
d) a processor, wherein the processor substantially uniformly samples the analog ring-down signal to generate a ring-down table having a multiplicity of data points, each point having a time and a value, and wherein the processor constructs a digital ring-down signal comprising consecutive data points in the ring-down table which lie within a selected fitting window, and wherein the processor calculates an estimate T1 of a ring-down time by averaging the time separation of data points within said fitting window which differ in value by a predetermined ratio, and wherein the processor calculates a first estimate B1 of a background level by averaging the values of data points in a background range of said digital ring-down signal, and wherein the processor calculates a corrected digital signal having values which are substantially equal to the values of said digital ring-down signal minus B1 within a final fitting window, and wherein the processor calculates an estimate τ* of the ring-down time using weighted linear regression of a logarithm of the values of said corrected digital-signal and wherein the processor calculates an estimated error ΔB in the estimate B1 of the background using the estimate τ* and wherein the processor calculates an estimated error Δτ in the estimate τ* using the estimated error ΔB and the estimate τ*, and wherein the processor calculates the ring-down time using the estimate τ* and the estimated error Δτ.
